(19) United States
(12) Patent Application Publication
(10) Pub. No.: US 2024/0304937 A1
(43) Pub. Date: Sep. 12, 2024

(54) ELECTRIC VEHICLE BATTERY ASSEMBLY WITH TWO-PHASE VENT

(71) Applicant: Ford Global Technologies, LLC, Dearborn, MI (US)

(72) Inventors: S.M. Iskander Farooq, Novi, MI (US); Mohammad Omar Faruque, Ann Arbor, MI (US); Dean M. Jaradi, Macomb, MI (US)

(73) Assignee: Ford Global Technologies, LLC, Dearborn, MI (US)

(21) Appl. No.: 18/178,761

(22) Filed: Mar. 6, 2023

(51) Int. Cl. H01M 50/333; B60L 3/00; H01M 50/249; H01M 50/30

(52) U.S. Cl. CPC H01M 50/333; B60L 3/0046; H01M 50/249; H01M 50/394; H01M 2220/20

(57) ABSTRACT

The electric-vehicle battery assembly includes a battery enclosure defining a cavity and includes battery cells enclosed by the battery enclosure in the cavity. An outlet extends through the battery enclosure and in fluid communication with the cavity. A vent includes a frame moveably supported by the battery enclosure. The frame is moveable relative to outlet between an open position allowing fluid flow from the cavity between the outlet and the frame and a closed position preventing fluid flow from the cavity between the outlet and frame. The vent includes a microporous membrane supported by the frame.

### BACKGROUND

A battery-electric vehicle includes one or more batteries (i.e. electric-vehicle batteries) that power the vehicle, including propulsion of the vehicle. For example, wheels of the vehicle are powered by electric motors that are powered by the electric-vehicle batteries. The electric-vehicle batteries may also power lighting, electronics, etc. The electric-vehicle battery may be stored in a battery compartment that may be, for example, under a passenger cabin of the vehicle.

The electric-vehicle battery includes battery cells enclosed in a battery enclosure. In such an example, the battery cells are stacked in the battery enclosure. As one example, the battery cells may be lithium-ion battery cells. Under certain conditions, one or more of the battery cells may release gas and/or heat. This increases the pressure and the temperature in the battery enclosure.

The battery cells have operating temperatures. In the event that the temperature of one of the battery cells exceeds the operating temperature, the battery cell may enter a thermal condition. In such an event, a chain reaction in the battery cell causes a rapid generation of heat and this this temperature rise of the battery causes gassing, i.e., release of gas from the battery cell. This increase in temperature of the battery cell and emission of gas by the battery cell increases the temperature and pressure of the battery enclosure. In some situations, this increase in temperature and pressure of the battery enclosure and/or the increase in temperature of the battery cell itself may cause one or more adjacent battery cells to also exceed the operating temperature and enter a thermal condition and, in some situations, this may cause a chain reaction of battery cells entering the thermal condition. After a thermal condition, the battery cells may be irreversibly damaged and inoperative thereafter.

### BRIEF DESCRIPTION OF THE DRAWINGS

FIG. 1 is a perspective view of a vehicle including an electric-vehicle batter assembly.

FIG. 2 is a perspective view of the electric-vehicle batter assembly with a vent in a closed position.

FIG. 3 is a perspective view of the electric-vehicle batter assembly with a vent in an open position.

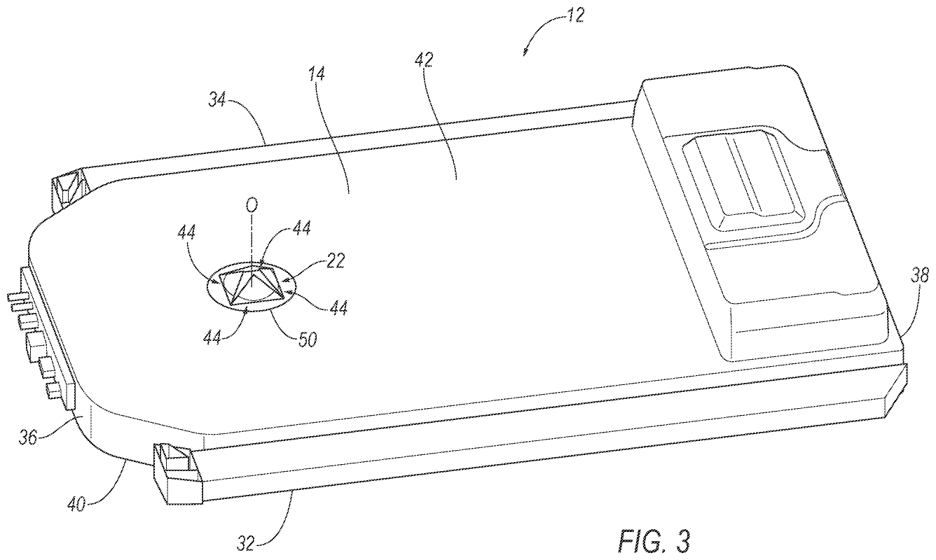

FIG. 4A is a perspective view of the vent in the closed position.

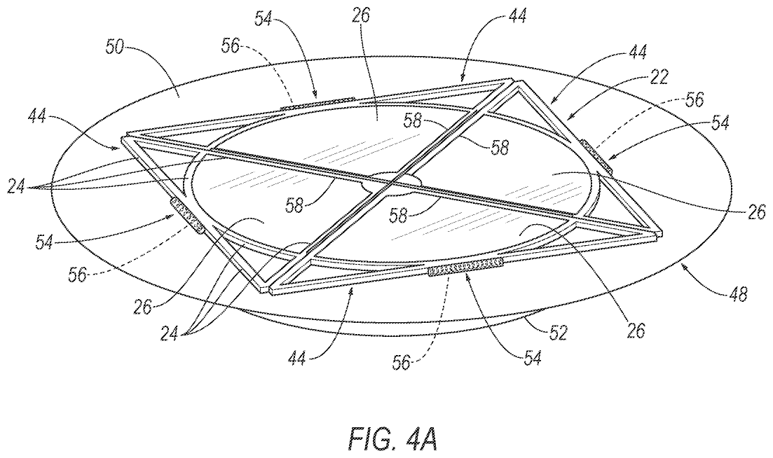

FIG. 4B is a perspective view of the vent in the closed position with vent bodies in broken lines to show an outlet.

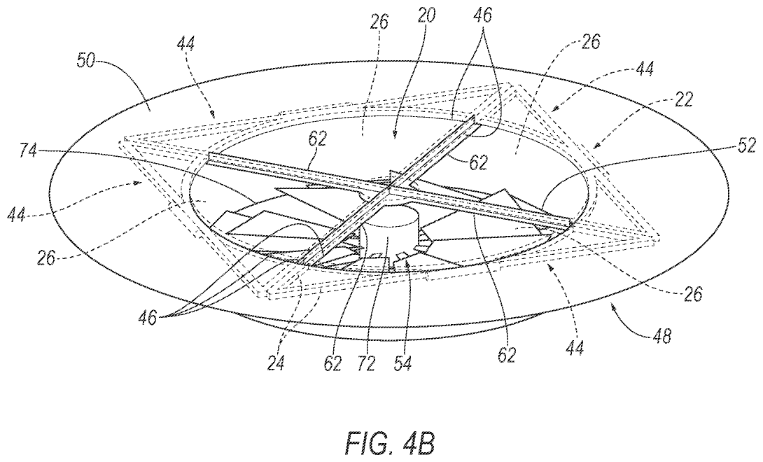

FIG. 5 is a perspective view of the vent in the open position.

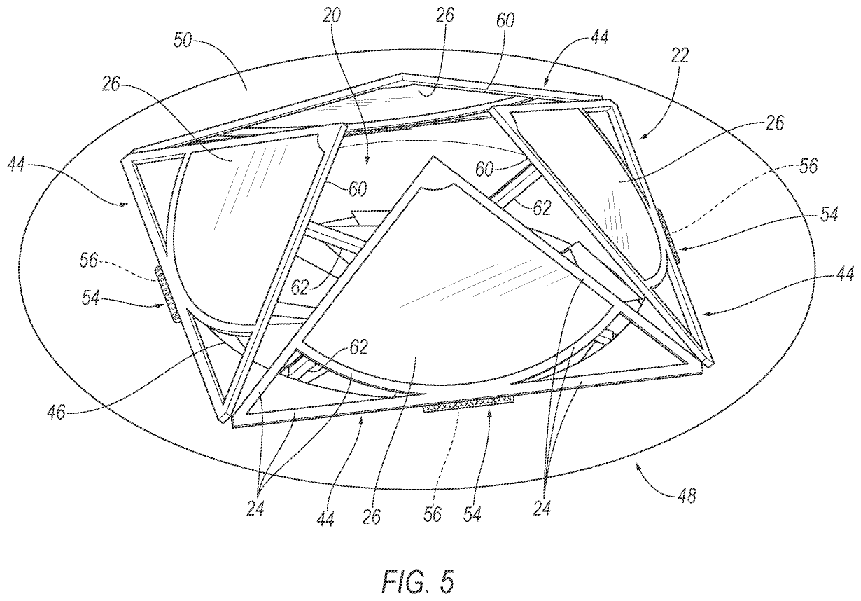

FIG. 6 is a perspective view of one of the vent bodies.

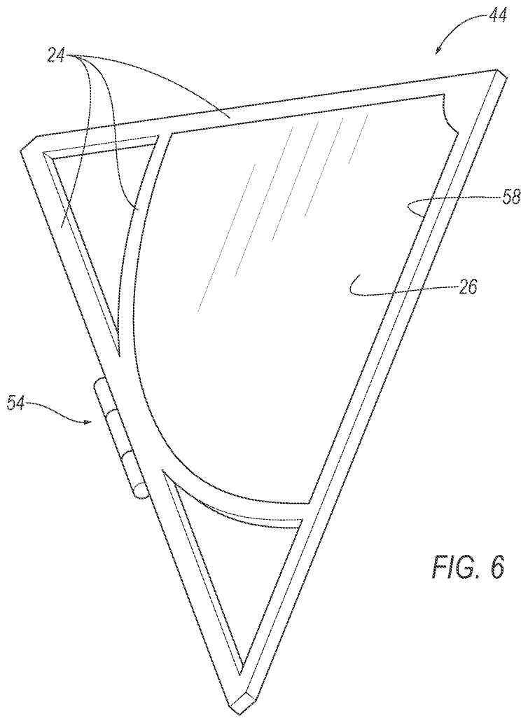

FIG. 7 is a schematic of a system of the vehicle.

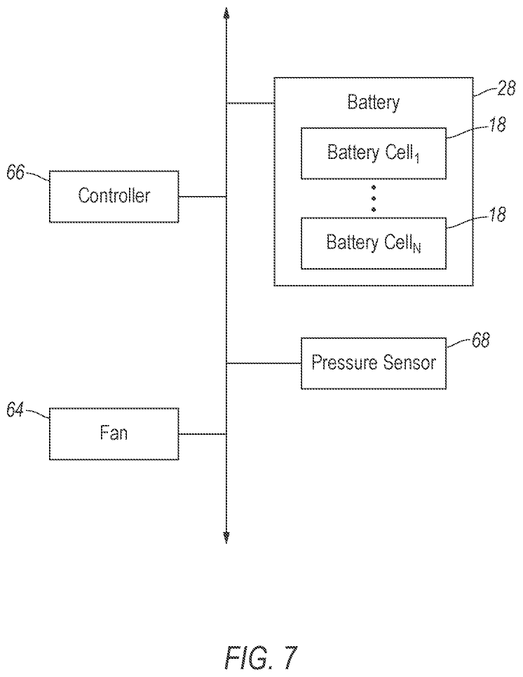

### DETAILED DESCRIPTION

An electric-vehicle battery includes a battery enclosure defining a cavity, battery cells enclosed by the battery enclosure in the cavity, and an outlet extending through the battery enclosure and in fluid communication with the cavity. A vent includes a frame moveably supported by the battery enclosure. The frame is moveable relative to outlet between an open position allowing fluid flow from the cavity between the outlet and the frame and a closed position preventing fluid flow from the cavity between the outlet and frame. The vent includes a microporous membrane supported by the frame.

The microporous membrane may be expanded polytetrafluoroethylene (ePTFE).

The vent may include a spring biasing frame toward the closed position.

The frame may seal to the battery enclosure in the closed position. The frame may define an opening in fluid communication with the outlet and the microporous membrane may cover the opening. The outlet may have an axis and the opening may be on the axis.

The frame may define an opening and the microporous membrane may cover the opening.

The frame may seal to the battery enclosure in the closed position and the frame may be spaced from the battery enclosure in the open position. The vent may include a fitting extending through the battery enclosure, and the fitting may define the outlet. A sealing surface of the frame may abut the fitting and may be sealed to the fitting to seal to the battery enclosure in the closed position and the sealing surface may be spaced from the fitting in the open position.

The frame may be rigid relative to the microporous membrane.

The frame may be rotatably coupled to the battery enclosure and the frame may be rotatable relative to the battery enclosure between open position and the closed position.

The vent may include a fitting extending through the battery enclosure and the fitting may define the outlet. The frame may define an opening in fluid communication with the outlet and the microporous membrane may cover the opening. The outlet may have an axis and the opening is on the axis. The frame may define an opening and the microporous membrane may cover the opening. A sealing surface of the frame may abut the fitting and may be sealed to the fitting in the closed position and the sealing surface may be spaced from the fitting in the open position. The frame may be rotatably coupled to the fitting.

A fan may be adjacent the vent between the vent and the cavity. The fan may be operable to move the vent to the open position. A controller may have a processor and memory storing instructions executable by the processor to activate the fan in response to detection of pressure in the cavity above a predetermined threshold.

With reference to the Figures, wherein like numerals indicate like parts throughout the several views, an electric-vehicle battery assembly 12 is generally shown. The electric-vehicle battery assembly 12 includes a battery enclosure 14 defining a cavity 16 and includes battery cells 18 enclosed by the battery enclosure 14 in the cavity 16. An outlet 30 extends through the battery enclosure 14 and in fluid communication with the cavity 16. A vent 22 includes a frame 24 moveably supported by the battery enclosure 14. The frame 24 is moveable relative to outlet 30 between an open position allowing fluid flow from the cavity 16 between the outlet 30 and the frame 24 and a closed position preventing fluid flow from the cavity 16 between the outlet 30 and frame 24. The vent 22 includes a microporous membrane 26 supported by the frame 24.

The vent 22 provides two-phase venting to vent pressure build-up in the battery enclosure 14. Specifically, in the event of pressure increase in the cavity 16 exceeding ambient pressure exterior to the battery enclosure 14, the microporous membrane 26 allows fluid flow across the microporous membrane 26 to vent pressure from the cavity 16. In a first phase of venting, in the event the pressure increase in the cavity 16 is insufficient to move the vent 22 from the closed position to the open position, the vent 22 remains in the closed position while pressure equilibrates across the microporous membrane 26. In a second phase of venting, in the event the pressure increase in the cavity 16 is sufficient to move the vent 22 to the open position, the pressure moves the vent 22 to the open position and pressure is released from the cavity 16 to the environment around the battery enclosure 14. This venting reduces the pressure and temperature of the cavity 16 of the battery enclosure 14.

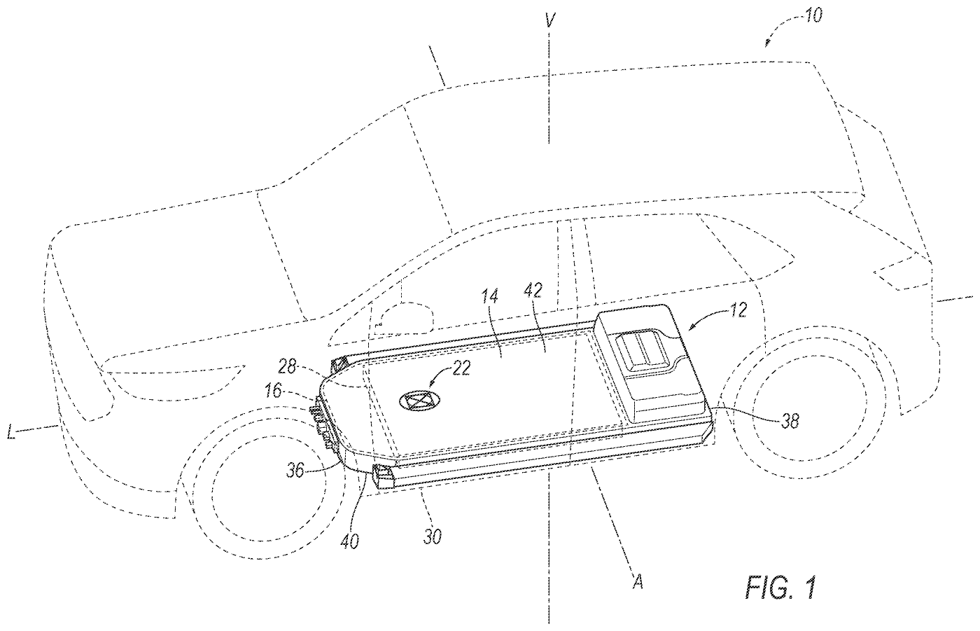

With reference to FIG. 1, the vehicle 10 may be any suitable type of automobile, e.g., a passenger or commercial automobile such as a sedan, a coupe, a truck, a sport utility, a crossover, a van, a minivan, a taxi, a bus, etc. In some examples, the vehicle 10 may be autonomous. In other words, the vehicle 10 may be autonomously operated such that the vehicle 10 may be driven without constant attention from a driver, i.e., the vehicle 10 may be self-driving without human input. The vehicle 10, specifically the electric-vehicle battery assembly 12, includes an electric-vehicle battery 28 that powers propulsion of the vehicle 10, e.g., the vehicle 10 may be battery-electric (BEV), hybrid electric, plug-in hybrid electric (PHEV), etc.

With reference to FIG. 1, the vehicle 10 defines a vehicle-longitudinal axis L extending between a front end (not numbered) and a rear-end (not numbered) of the vehicle 10. The vehicle 10 defines a vehicle-lateral axis A extending cross-vehicle 10 from one side to the other side of the vehicle 10. The vehicle 10 defines a vertical axis V extending through the floor and ceiling of the vehicle 10. The vehicle-longitudinal axis L, the vehicle-lateral axis A, and the vertical axis V are perpendicular relative to each other.

With continued reference to FIGS. 1, the vehicle 10 includes the vehicle frame. As one example, the vehicle frame may be of a unibody construction in which the vehicle frame is unitary with a vehicle body (including frame rails, pillars, roof rails, etc.). As another example, the vehicle body and the vehicle frame may have a body-on-frame 24 construction (also referred to as a cab-on-frame 24 construction) in which the vehicle body and the vehicle frame are separate components, i.e., are modular, and the vehicle body is supported on and affixed to the vehicle frame. In other examples, the vehicle frame and the vehicle body may have any suitable construction. The vehicle frame and the vehicle body may be of any suitable material, for example, steel, aluminum, and/or fiber-reinforced plastic, etc.

The vehicle frame includes a frame rail on a left side of the vehicle 10 and a frame rail on a right side of the vehicle 10. The frame rails may be tubular. The frame rails are spaced from each other along the cross-vehicle axis C. Specifically, the frame rails may define the vehicle outboard boundaries of the vehicle frame. The first frame rail and the second frame rail may be aligned cross-vehicle 10 with wheel wells and wheels of the vehicle 10, i.e., extending from one wheel well to another wheel well on a common side of the vehicle 10. The vehicle 10 may include rockers 30 elongated along the vehicle-longitudinal axis L below doors of the vehicle 10 and extending along the frame rails, respectively. The rockers 30 may be fixed to and/or supported by the frame rails, respectively. The electric-vehicle battery assembly 12 including the battery enclosure 14 is disposed between the frame rails and/or between the rockers 30.

The frame rails and rockers 30 are elongated in a vehicle-longitudinal direction, i.e., along the vehicle-longitudinal axis L. The frame rails may be elongated at least from one wheel well to another wheel well. In addition, the frame rails may extend forward of a front wheel well and rearward of a rear wheel well, e.g., by extending inboard and/or above the wheel well.

The electric-vehicle battery 28 may be of any suitable type for vehicular electrification, i.e., for powering propulsion of the vehicle 10. For example, the electric-vehicle battery 28 may be lithium-ion batteries, nickel-metal hydride batteries, lead-acid batteries, or ultracapacitors, as used in, for example, plug-in hybrid electric vehicle 10s (PHEVs), hybrid electric vehicle 10s (HEVs), or battery electric vehicle 10s (BEVs). The electric-vehicle 10 batteries may be arranged as battery modules. In examples including multiple battery modules, adjacent ones of the battery modules are connected to each other. Each battery module may include a plurality of battery cells 18. The cavity 16 of the battery enclosure 14 may house the electric-vehicle 10 batteries.

The electric-vehicle battery assembly 12 includes the electric-vehicle battery 28 and the battery enclosure 14. In examples including multiple battery modules, adjacent ones of the battery modules are connected to each other in the cavity 16 of the battery enclosure 14. In such examples, each battery module may include a plurality of battery cells 18. The battery assembly 12 may include any suitable hardware, e.g., wiring, connectors, circuits, etc., connecting the battery modules to each other and to electrified components of the vehicle 10.

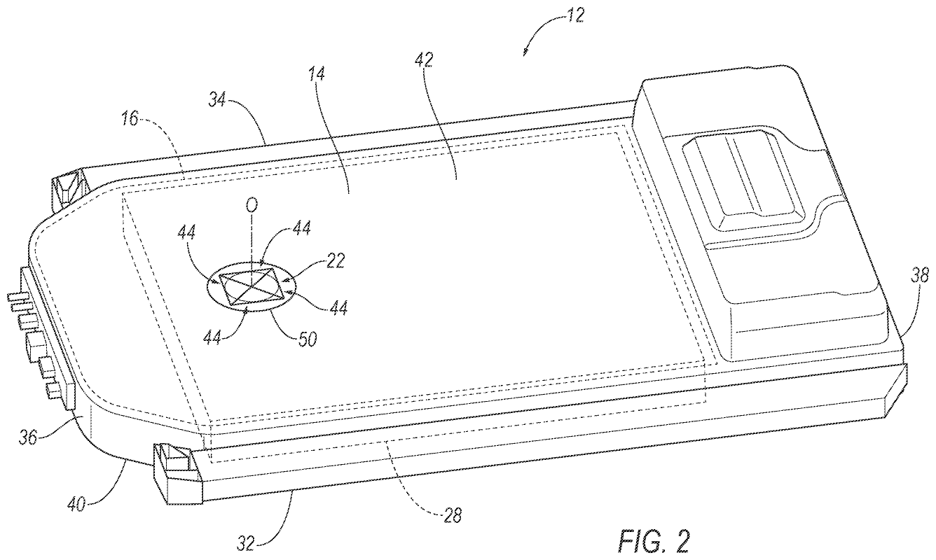

With reference to FIGS. 1 and 2, the battery enclosure 14 defines the cavity 16 that houses the electric-vehicle battery 28. The battery enclosure 14 may be plastic, metal, or any suitable material. The battery enclosure 14 is supported by the vehicle frame, e.g., by direct attachment or indirect attachment through another component.

The battery enclosure 14 extends from one frame rail to the other frame rail and/or from one rocker 30 to the other rocker 30. The battery enclosure 14 may be continuous from the rail to rail. Specifically, the battery enclosure 14 may span the entire underbody of the vehicle 10 from one rail to the other rail. The battery enclosure 14 supports one or more electric-vehicle batteries 28, as described further below. The battery enclosure 14 supports hardware associated with the electric-vehicle battery 28 such as wiring, cooling hardware, mounting hardware, etc.

With continued reference to FIGS. 1 and 2, the battery enclosure 14 is sized and shaped to enclose the electric-vehicle battery 28. As an example, the battery enclosure 14 may include a first side member 32 and a second side member 34. The first side member 32 and the second side member 34 may define outboard boundaries of the battery enclosure 14, as shown in the example in the Figures. The battery enclosure 14 may include a front wall 36, a rear wall 38, a bottom panel 40, and/or a top panel 42 each extending from the first side member 32 and the second side member 34. The bottom panel 40 may be exposed to the road surface and may prevent intrusion of precipitation and dirt to the battery cells 18. The top panel 42 may separate the battery compartment from components of the vehicle 10 above the battery enclosure 14, e.g., a passenger compartment.

As set forth above, the battery enclosure 14 defines the cavity 16. The battery 28, specifically the battery cells 18, are enclosed by the battery enclosure 14 in the cavity 16. In other words, the cavity 16 is environmentally sealed by the battery enclosure 14, i.e., to prevent intrusion of road precipitation and dirt. For example, in the example, shown in the Figures, the first side member 32, second side member 34, front wall 36, rear wall 38, bottom panel 40, and top panel 42 enclose the electric-vehicle battery 28. Specifically, the first side member 32, second side member 34, front wall 36, rear wall 38, bottom panel 40, and top panel 42 are sealed to each other such that the battery enclosure 14 is environmentally sealed, i.e., to prevent intrusion of road precipitation and dirt. The bottom panel 40 and the top panel 42 may be fixed to the first side member 32, the second side member 34, the front wall 36, and/or the rear wall 38, e.g., welding, adhesive, bonding, unitary formation, etc. In such examples, the first side member 32, the second side member 34, front wall 36, rear wall 38, bottom panel 40, and top panel 42 may be hermetically sealed to each other and formed of material that prevents fluid flow therethrough. In other examples, at least one of the first side member 32, the second side member 34, front wall 36, rear wall 38, bottom panel 40, and top panel 42 may include a second microporous membrane to allow for pressure equilibration, in conjunction with the vent 22 described further below, for instances in which pressure builds in the cavity 16. In such examples, the second microporous membrane may be of the same type of material as the microporous membrane 26 of the vent 22.

The battery enclosure 14 defines, at least in part, an outlet 30 extending through the battery enclosure 14 and in fluid communication with the cavity 16. In the event of pressure increase in the cavity 16 above the pressure of the environment exterior to the battery enclosure 14, the vent 22 allows for pressure equilibration between the cavity 16 and the environment exterior to the battery enclosure 14. In the example shown in the Figures, the outlet 30 extends through the top panel. In other examples, the outlet 30 may extend through any one of the first side member 32, the second side member 34, front wall 36, rear wall 38, bottom panel 40, and/or top panel 42. In the example shown in the Figures, the electric-vehicle battery assembly 12 includes one outlet 30 and one vent 22 and, in other examples, the battery assembly 12 may include more than one outlet 30 and respective vent 22 in any one or combination of the first side member 32, second side member 34, front wall 36, rear wall 38, bottom panel 40, and/or top panel 42.

As set forth above, the vent 22 provides two-phase venting to vent pressure buildup in the battery enclosure 14 to reduce pressure and temperature of the cavity 16 of the battery enclosure 14. In the first phase of venting, in the event the pressure increase in the cavity 16 is insufficient to move the vent 22 from the closed position to the open position, the vent 22 remains in the closed position while pressure equilibrates across the microporous membrane 26. In the event that the pressure buildup in the cavity 16 exceeds the pressure equilibration across the microporous membrane 26, the vent 22 may enter the second phase of venting. In the second phase of venting, the pressure increase in the cavity 16 is sufficient to move the vent 22 to the open position and the pressure moves the vent 22 to the open position. In the open position, the vent 22 releases pressure from the cavity 16 through the outlet 30 to the environment around the battery enclosure 14. This venting reduces the pressure and temperature of the cavity 16 of the battery enclosure 14.

As set forth above, in the open position, the vent 22 releases pressure from the cavity 16 through the outlet 30 to the environment around the battery enclosure 14. Specifically, the frame 24 of the vent 22 and the microporous membrane 26 is moved to the open position, as described below, opening 58 a flow path through the vent 22 that circumvent 22s flow through the microporous membrane 26. In the open position, resistance to flow through the vent 22 is less than in the closed position.

As set forth above, the vent 22 includes the frame 24 and the microporous membrane 26. Specifically, the vent 22 includes a vent body 44 and a vent seat 46. The vent body 44 includes the frame 24 and the microporous membrane 26. The vent body 44, i.e., the frame 24 and/or the microporous membrane 26, seals the outlet 30 from the environment exterior to the battery enclosure 14 in the closed position and opens the outlet 30 to the environment exterior to the battery enclosure 14 in the open position, as described further below.

The vent 22 may include more than one vent body 44. In the example shown in the Figures, the vent 22 includes four vent bodies 44. In such an example, each vent body 44 includes at least one frame 24 and at least one microporous membrane 26. The frame 24, for example, may be plastic, metal, composite, or any other suitable material.

The microporous membrane 26 is supported by the frame 24. In other words, the weight of the microporous membrane 26 is borne by the frame 24. Accordingly, the microporous membrane 26 moves with the frame 24 as the frame 24 moves between the open position and the closed position, as described further below. The frame 24 may be rigid relative to the microporous membrane 26. In other words, the frame 24 may maintain shape and the microporous membrane 26 may flex relative to the frame 24 when subjected to certain forces. In instances in which the pressure in the cavity 16 is sufficient to move the vent 22 to the open position, the frame 24 moves to the open position and the microporous membrane 26 moves with the frame 24.

The microporous membrane 26 is air-permeable. Accordingly, the microporous membrane 26 allows for pressure in the cavity 16 and pressure exterior to the battery enclosure 14 to equilibrate across the vent 22 at a rate commensurate with the permeability of the microporous membrane 26, i.e., in the first phase of venting. The microporous membrane 26 includes holes, e.g., pores, channels, etc., that allow for fluid flow and limit or prevent passage of dirt and precipitation across the microporous membrane 26. The holes may have a diameter in the nanometer range, i.e., less than 1 micrometer. As an example, the holes may have a diameter less than 10 nanometers. The microporous membrane 26, for example, may be a sheet having the holes. The holes may be formed, for example, during the formation of the material of the sheet of the microporous membrane 26. As an example, the microporous membrane 26 may be expanded polytetrafluoroethylene (ePTFE). As another example, the microporous membrane 26 may be fabric. In such examples, the microporous membrane 26 includes woven fibers defining the holes between the fiber. The microporous membrane 26 may have any suitable thickness to vent in the first stage of venting as described above.

The vent 22 may include a fitting 48. In such examples, the fitting 48 extends through the battery enclosure 14. The fitting 48 and the battery enclosure 14 in combination define the outlet 30. The outlet 30 extends through both the fitting 48 and the battery enclosure 14. In the example shown in the Figures, the fitting 48 includes a flange 50 and a throat 52. The flange 50 abuts the battery enclosure 14. The outlet 30 extends through the throat 52. The fitting 48 may be fixed to the battery enclosure 14 in any suitable fashion such as welding, adhesive, bonding, unitary formation, etc. The connection between the fitting 48 and the battery enclosure 14 is sealed and impermeable to airflow.

The vent body 44, and specifically the frame 24, is moveably supported by the battery enclosure 14. In other words, the weight of the frame 24 is borne by the battery enclosure 14. For example, the frame 24 may be directly or indirectly supported by the battery enclosure 14. In the example shown in the Figures, the frame 24 is supported directly by the fitting 48 and the frame 24 is supported indirectly, i.e., through the fitting 48, by the battery enclosure 14.

The frame 24 is moveable relative to the outlet 30 between an open position allowing fluid flow from the cavity 16 between the outlet 30 and the frame 24 and a closed position preventing fluid flow from the cavity 16 between the outlet 30 and frame 24. In the example shown in the Figures, the frame 24 is moveable relative to the fitting 48 and the battery enclosure 14 between closed position and the open position.

In one example, such as the example shown the Figures, the frame 24 is rotatably coupled to the battery enclosure 14, the frame 24 being rotatable relative to the battery enclosure 14 between open position and the closed position. For example, as shown in the example shown in the Figures, the frame 24 is rotatably coupled to the battery enclosure 14 through the fitting 48, i.e., is indirectly coupled to the battery enclosure 14. Specifically, in such an example, the frame 24 is rotatably coupled to the fitting 48, e.g., the flange 50 as shown in the example shown in the Figures. In the example shown in the Figures, the vent 22 includes a hinge 54 between the frame 24 and the fitting 48, e.g., the flange 50. The hinge 54 may be of any suitable type such as, for example, a butt hinge.

The vent 22 may be spring-loaded. For example, the vent 22 may include a spring 56 biasing the frame 24 toward the closed position. In the example shown in the Figures, the hinge 54 may be spring-loaded. Specifically, the spring 56 may be grounded to the fitting 48 and the frame 24 of the vent 22 and may be positioned to bias the frame 24 toward the closed position. In the example shown in the Figures, the hinge 54 is a spring-loaded butt hinge. In the event the pressure increase in the cavity 16 is insufficient to overcome the bias of the spring 56, the vent 22 remains in the closed position while pressure equilibrates across the microporous membrane 26. In the event the pressure increase in the cavity 16 is sufficient to overcome the bias of the spring 56, the pressure rotates the vent 22 to the open position against the bias of the spring 56. When pressure in the cavity 16 decreases, due to venting, the spring 56 returns the vent 22 to the closed position.

As set forth above, the frame 24 and/or the microporous membrane 26 seals the outlet 30 from the environment exterior to the battery enclosure 14 in the closed position and opens the outlet 30 to the environment exterior to the battery enclosure 14 in the open position. In the closed position, the microporous membrane 26 vents in the first phase of venting as described above. In the open position, the vent 22 allows flow through the outlet 30 from the without passing through the microporous membrane 26.

The frame 24 defines an opening 58 in fluid communication with the outlet 30, the microporous membrane 26 covers the opening 58. As an example, the outlet 30 has an axis O and the opening 58 is on the axis O when the vent 22 is in the closed position. In the closed position the frame 24 of the vent 22 is sealed to the battery enclosure 14, as described below, and the opening 58 of the frame 24 is exposed to the outlet 30 so that air flows through the opening 58 and the microporous membrane 26. Specifically, for pressure build-up in the cavity 16 that is insufficient to move the vent 22 to the open position, gas flows through the opening 58 the microporous membrane 26.

The frame 24 seals to the battery enclosure 14 in the closed position. In other words, the frame 24 in the closed position prevents fluid flow between the frame 24 and the battery enclosure 14. The frame 24 is spaced from the battery enclosure 14 in the open position to allow for fluid flow between the frame 24 and the battery enclosure 14.

In the example shown in the Figures, vent seat 46 is on the fitting 48 and, in the closed position, a sealing surface 60 of the frame 24 abuts the fitting 48 and is sealed to the fitting 48, specifically the vent seat 46, to seal to the battery enclosure 14 in the closed position. In such an example, the sealing surface 60 is spaced from the fitting 48, specifically the vent seat 46, in the open position. In the example shown in the Figures in which the fitting 48 includes more than one vent body 44, the fitting 48 includes cross-beams 62 extending across the outlet 30, e.g., transverse to the outlet 30, such as perpendicular to the axis O of the outlet 30 as shown in the example in the Figures. In such an example, the vent seat 46 extends along the flange 50 and the cross-members 62, and the frame 24 abuts both the flange 50 and the cross-members 62 in the closed position. The sealing surface 60 of the frame 24 and/or the vent seat 46 in the closed position may include a seal (not shown) of a material to encourage sealing between the frame 24 and fitting 48, e.g., rubber.

The electric-vehicle battery assembly 12 may include a fan 64 for blowing air through the outlet 30 from the cavity 16 to the environment exterior to the battery enclosure 14 when the vent 22 is open. The fan 64 may be between the vent 22 and the cavity 16. For example, the fan 64 may be adjacent the vent 22, i.e., with the absence of any other component between the fan 64 and the vent 22. The fan 64 may be in the outlet 30. The fan 64 may be of any suitable type, e.g., a propeller fan, a centrifugal fan, or any suitable type of fan 64. The fan 64 includes a motor 72 and a blade 74. The blade 74 may be a propeller, impeller, etc.

In examples including the fan 64, the fan 64 may be operable to move the vent 22 to the open position. In such an example, the operation of the fan 64 moves the vent 22 to the open position. As an example, an exhaust side of the fan 64 may be pointed at the vent 22 such that exhaust from the fan 64 urges the vent 22 to move from the closed position toward the open position. In examples including the spring 56 in the hinge 54, as shown in the Figures, the pressure at the exhaust side of the fan 64 is of a magnitude and location to move the vent 22 to the open position against the bias of the spring 56 when the fan 64 is operated.

The vehicle 10 may include a controller 66 having a processor and a memory storing instructions executable by the processor to control operation of the fan 64. The controller 66 may be, for example, a battery control module. Use of “in response to,”“based on,” and “upon determining” herein indicates a causal relationship, not merely a temporal relationship.

The vehicle 10 may include a pressure sensor 68 for measuring the temperature of the cavity 16 of the battery enclosure 14. The pressure sensor 68 may, for example, be in the cavity 16 of the battery enclosure 14. The pressure sensor 68 may be of any suitable type for measuring the pressure of the cavity 16 with sufficient sensitivity to detect pressure increase before a thermal condition.

The controller 66 has a processor and memory storing instructions executable by the processor to activate the fan 64 in response to detection of pressure in the cavity 16 above a predetermined threshold. For example, the controller 66 may activate the fan 64 in response to detection of pressure above the threshold by the pressure sensor 68. The predetermined threshold of pressure in the cavity 16 may, for example, be determined empirically or in any other suitable fashion. As set forth above, when the fan 64 is activated, the fan 64 may move the vent 22 to the open position.

The controller 66 in the Figures illustrates an example storage medium. Storage medium may be any non-transitory computer-readable storage medium or machine-readable storage medium, such as an optical, magnetic or semiconductor storage medium. In various implementations, storage medium may be an article of manufacture. In some implementations, storage medium may store computer-executable instructions, such as computer-executable instructions to implement logic flow. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some implementations, the circuitry may be implemented in, or functions associated with the circuitry may be implemented by, one or more software or firmware modules. In some implementations, circuitry may include logic, at least partially operable in hardware.

The vehicle 10 includes a communication network 70 that can include a bus in the vehicle 10 such as a controller area network (CAN) or the like, and/or other wired and/or wireless mechanisms. Via the vehicle network 70, the controller 66 may transmit messages to various devices in the vehicle 10 and/or receive messages (e.g., CAN messages) from the various devices, e.g., sensors, an actuator, a human machine interface (HMI), etc. Alternatively or additionally, in cases where the controller 66 comprises a plurality of devices, the vehicle communication network 70 may be used for communications between devices represented as the controller 66 in this disclosure. Further, as mentioned below, various controllers and/or sensors may provide data to the controller via the vehicle communication network 70.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An electric-vehicle battery comprising:
a battery enclosure defining a cavity;
battery cells enclosed by the battery enclosure in the cavity;
an outlet extending through the battery enclosure and in fluid communication with the cavity;
a vent including a frame moveably supported by the battery enclosure, the frame being moveable relative to outlet between an open position allowing fluid flow from the cavity between the outlet and the frame and a closed position preventing fluid flow from the cavity between the outlet and frame;
the vent including a microporous membrane supported by the frame.

2. The electric-vehicle battery of claim 1, wherein the microporous membrane is expanded polytetrafluoroethylene (ePTFE).

3. The electric-vehicle battery of claim 1, wherein the vent includes a spring biasing frame toward the closed position.

4. The electric-vehicle battery of claim 1, wherein the frame seals to the battery enclosure in the closed position.

5. The electric-vehicle battery of claim 4, wherein the frame defines an opening in fluid communication with the outlet, the microporous membrane covering the opening.

6. The electric-vehicle battery of claim 4, wherein the outlet has an axis and the opening is on the axis.

7. The electric-vehicle battery of claim 1, wherein the frame defines an opening, the microporous membrane covering the opening.

8. The electric-vehicle battery of claim 1, wherein the frame seals to the battery enclosure in the closed position and the frame is spaced from the battery enclosure in the open position.

9. The electric-vehicle battery of claim 8, wherein the vent includes a fitting extending through the battery enclosure, the fitting defining the outlet; and
a sealing surface of the frame abuts the fitting and is sealed to the fitting to seal to the battery enclosure in the closed position and the sealing surface is spaced from the fitting in the open position.

10. The electric-vehicle battery of claim 1, wherein the frame is rigid relative to the microporous membrane.

11. The electric-vehicle battery of claim 1, wherein the frame is rotatably coupled to the battery enclosure, the frame being rotatable relative to the battery enclosure between open position and the closed position.

12. The electric-vehicle battery of claim 1, wherein the vent includes a fitting extending through the battery enclosure, the fitting defining the outlet.

13. The electric-vehicle battery of claim 12, wherein the frame defines an opening in fluid communication with the outlet, the microporous membrane covering the opening.

14. The electric-vehicle battery of claim 13, wherein the outlet has an axis and the opening is on the axis.

15. The electric-vehicle battery of claim 12, wherein the frame defines an opening, the microporous membrane covering the opening.

16. The electric-vehicle battery of claim 12, wherein a sealing surface of the frame abuts the fitting and is sealed to the fitting in the closed position and the sealing surface is spaced from the fitting in the open position.

17. The electric-vehicle battery of claim 12, wherein the frame is rotatably coupled to the fitting.

18. The electric-vehicle battery of claim 1, further comprising a fan adjacent the vent between the vent and the cavity.

19. The electric-vehicle battery of claim 18, wherein the fan is operable to move the vent to the open position.

20. The electric-vehicle battery of claim 18, further comprising a controller having a processor and memory storing instructions executable by the processor to activate the fan in response to detection of pressure in the cavity above a predetermined threshold.
